(19) United States
(12) Patent Application Publication
(10) Pub. No.: US 2016/0041076 A1
(43) Pub. Date: Feb. 11, 2016

(54) A METHOD AND A DEVICE FOR ASSESSING WHETHER A DRUG OF ABUSE AND/OR A METABOLITE THEREFOF IS PRESENT IN A KERATIN MATERIAL

(71) Applicant: UNIVERSITA' DI PISA, Pisa (IT)

(72) Inventors: Silvio CHERICONI, Massa (IT); Mario GIUSIANI, Pisa (IT); Fabio STEFANELLI, San Giuliano Terme (IT)

(21) Appl. No.: 14/782,660

(22) PCT Filed: Apr. 7, 2014
(86) PCT No.: PCT/IB2014/060507

§ 371 Date: Oct. 6, 2015

(30) Foreign Application Priority Data
Apr. 6, 2013 (IT) PI2013A000026

(51) Int. Cl. G01N 1/40; G01N 1/44

(52) U.S. Cl. CPC G01N 1/4044; G01N 1/44; G01N 1/4055; G01N 2001/4061

(57) ABSTRACT

A method and a device, for assessing whether a drug of abuse and/or a metabolite of a drug of abuse is present in a keratin material, where the method includes extracting a drug of abuse and/or a metabolite from a subject's keratin material, by prearranging an amount of the keratin material; prearranging an extraction composition; bringing the keratin material into contact with the extraction composition in order to obtain an extract that contains the drug of abuse and/or the metabolite, wherein the extraction composition contains a compound selected among urea and urea derivatives.

### FIELD OF THE INVENTION

The present invention relates to a method and to a device for assessing whether a subject has taken and/or habitually takes one or several drugs of abuse, by analysing a subject's hair material, for example hair or other hair material.

### TECHNICAL FRONT

### Technical Problems

Laboratory methods are known for assessing whether a subject has taken or usually takes drugs of abuse by analysing his/her keratin material. In particular:

immunochemical methods are known, which are based on an antigen-antibody interaction and can use, for instance, immunofluorescence or polarized light detection techniques;

chromatographic methods, which can use, for instance, gas chromatography or liquid chromatography techniques, in combination with mass spectrometry (GC-MS; LC-MS).

Both types of methods require that the keratin material is treated to extract any possible drugs, or metabolite thereof, and to obtain liquid samples that are subjected to the aforementioned analysis techniques. For example, a solution that can extract the most common drugs of abuse and provide samples suitable for immunochemical analysis is manufactured by the company COMEDICAL under the trade name “VMA”.

The two above mentioned methods require a professional equipment, which can be successfully used only by skilled personnel. This has several drawbacks:

the analysis equipment is very expensive;

the training of the personnel in charge of using this equipment is also very expensive;

the time required to prepare the samples for the analysis is not negligible;

the analysis cannot be carried out at home, in order to save the privacy, which the possible drug consumer's relatives are expected to wish;

### Moreover,

very precise amounts of keratin material must be used to prepare the keratin material for the extraction, which can be measured only by a precision scale;

some solvents used with the equipment can cause safety problems;

the above mentioned methods are not very reliable with cosmetically treated hair.

Devices are also known for quickly carrying out immunochromatographic quick tests, also known as “on site” kits, which makes it possible to assess qualitatively whether a subject has taken a drug of abuse, in an easy way and in a very short time, without requiring skilled personnel.

However, presently available immunochromatographic quick test devices can be used only for analysing such biological fluids as saliva and urine. The drugs of abuse and their metabolites have a relatively short residence time in these biological fluids. For instance, the opiates have a residence time on average of 48-72 hours in the urine, and an even lower residence time in the saliva.

In order to obtain reliable results, the urine or the saliva must be tested by a relatively short time after the drug intake. Therefore, these methods can only detect the so-called actuality of use, in case of the saliva, or a recent use, in case of the urine, and do not allow to assess a subject's previous or habitual use of drugs of abuse.

As shown in FIG. 1, an “on site” kit 10 essentially comprises a support 11 on which:

wells 12 are arranged to receive the sample;

porous strips 13 are also arranged that extend along the support starting from wells 12 and are in hydraulic connection with them, so that by putting a liquid sample in a well 12, the sample moves by capillary action along respective strip 13.

Each strip 13 is serves for revealing a specific class of drugs. To this purpose, each strip 13 comprises, starting from the well:

a zone 14, where a marked antigen is present, in a movable form, which is conjugate with the specific class of drugs, so that the sample, by moving along strip 13, takes away the marked antigen with itself;

a testing transversal line 15, where an antibody is fixedly embedded within the porous matrix of strip 13, said antibody adapted to react competitively with both the marked antigen, causing line 15 to become coloured, and the drugs of the specific class, in which case no colour appearance is observed;

a control transversal line 16, where a substance is fixedly embedded within the porous matrix, said substance adapted to combine with the sample, thus in which case it causing control line 16 to become coloured.

If a drug is present at a concentration lower than a so-called “cut-off” threshold, it cannot saturate the bond positions of the antibody, so that the antibody of test line 15 reacts with the marked antigen and the line of test 15 becomes coloured, when it is attained by the sample. On the contrary, if the concentration is higher than the cut-off value, the drug saturates the bond positions of the antibody and test line 15 does not become coloured.

Only a colour appearance in control line 16 indicates that the sample has correctly flown along strip 13 and reached test line 15. The absence of colour at control line 16 does not allow considering the test valid for the specific class of drugs. A cover 17 and windows 18 for seeing lines 15,16 on support 11 are the remaining parts of “on site” kit 10.

The immunochemical tests are not able to detect certain substances as such, like cocaine, which cannot be detected directly but only by cross reactivity. In this case the test detects a specific metabolite, i.e. benzoylecgonine.

Shin, Lee et al., in Analytical Biochemistry 407 (2020), pp. 281-283, “Microwave-assisted extraction of human hair proteins”, describe a process for extracting proteins from samples of human hair, where a solution containing a Tris HCl buffer (pH 8.5), thiourea, urea and mercaptoethanol, in the presence of the hair, is exposed to microwaves at a power of 600W for a time set between 5 and 120 minutes. The above indicated operating conditions are selected so as to degrade the keratin matrix, in order to allow the extraction of macromolecules such as proteins. By this treatment, an extract is obtained that cannot be treated by the above described immunochemical “on site” techniques.

### SUMMARY OF THE INVENTION

It is therefore a feature of the present invention to provide a method and a device for assessing whether a subject has taken or usually takes drugs of abuse, by examining his/her keratin material, that is easier and quicker to use than the prior art methods and devices in which keratin material is examined.

It is a particular feature of the present invention to provide a method and a device for easily and quickly extracting drugs of abuse and/or metabolites thereof from the keratin material, by which a solution can be obtained for use in an “on site” qualitative test, or in a instrumental laboratory immunochemical test.

It is also a feature of the invention to provide a method and a device for carrying out an “on site” qualitative test, in particular at home, starting from a subject's keratin material, in order to assess whether the subject has taken/habitually takes drugs of abuse.

These and other objects are achieved by a method for assessing whether a drug of abuse and/or a metabolite of a drug of abuse is present in a keratin material, the method comprising:
a step of extracting the drug of abuse and/or the metabolite from the keratin material, the step of extracting comprising:
   prearranging an amount of the keratin material;
   prearranging an amount of an extraction composition containing a compound selected from the group consisting of urea and urea derivatives;
   bringing the amount of the keratin material into contact with the amount of the extraction composition, obtaining an extract that contains the drug of abuse and/or the metabolite;
a step of analysing the extract by an antigen-antibody technique, comprising:
   performing a reaction of the drug of abuse and/or the metabolite, which acts as an antigen, with a specific antibody;
   detecting the antigen-antibody reaction.

Since urea and most useful urea derivatives are inexpensive and substantially no toxic substances, the method allows extracting drugs of abuse and/or metabolites thereof cheaply, easily and safely. As better described hereinafter, these and other features of the extracts that can be obtained by the method make it possible to ascertain at home the use, even a chronic use, of drugs of abuse, at a reduced cost and without health risks of people who are in charge of carrying out the tests.

In an exemplary embodiment, the reaction of the drug of abuse, and/or the metabolite with the specific antibody, is a first reaction, and the method comprises a step of comparing the first reaction with a second reaction between the antibody and a reference antigen for the drug of abuse and/or the metabolite.

In particular, the reference antigen is a marked antigen adapted to produce a visually detectable chromophore compound in the second reaction with the antibody. This way, it is possible to assess the presence of the drug, or of the metabolite of a drug, according to the colour of the product of the second reaction. More in particular, said reference antigen and said specific antibody are arranged on a respective strip of an immunochromatographic quick test.

In fact, the obtained extract, which contains the drug and/or a metabolite thereof, along with the urea and/or the urea derivative, is compatible with the substrates that are used to manufacture the qualitative immunochromatographic quick “on site” devices, which are currently available for saliva and urine tests. In other words, no significant interactions or interferences occur between the urea residues that are present in the extract and these substrates. Therefore, the method allows using the “on site” kits, which are currently used for urine or saliva tests, even for analysing a keratin material.

The method according to the invention, in this exemplary embodiment, allows therefore to benefit of the advantages both of the immunochromatographic quick test devices, i.e. user friendliness, quick response and low cost, and of the analysis of the keratin material, i.e. a reliable response even if the test is carried out after a relatively long time since when the drug has been taken, accordingly it makes it possible to ascertain a chronic use of the drug of abuse.

Moreover, the possibility to use qualitative immunochromatographic quick “on site” kits makes it possible to understand whether a subject has taken/usually takes drugs of abuse, without using laboratory instruments. For this reason, the method can be used at home, and provides a test result, which can be positive, while keeping it reserved. As described above, the method can be easily used at home, since urea and most urea derivatives are substantially no toxic substances, and the waste material can be disposed at a low cost.

Furthermore, the possibility to test a keratin material by a quick “on site” method can provide to the health institutions a screening system to establish which extracts, i.e. which subjects, must be investigated more quantitatively by more expensive methods such as GC-MS or LC-MS. This would reduce the costs and the time required for assessing whether a plurality of subjects has taken/usually takes a drug, without reducing the reliability of the assessment.

As an alternative, the antigen-antibody technique can be a technique to be performed by laboratory instruments, wherein the detection is based on a specific variation of a property of the antigen from when the latter is in a free state, to when it is in a state of combination with the antibody, such as luminescence, wave emission, and so on, by specific instruments. More in particular, the instrumentally implementable antigen-antibody technique can be selected from the group consisting of:

a Radio Immuno Assay (RIA) technique;

an Enzyme Immuno Assay (EIA) technique;

a MEIA technique (Microparticles Enzyme Immuno Assay);

a CEDIA technique (Cloned Enzyme Donor Immuno Assay);

a Fluorescence Polarization Immuno Assay (FPIA) technique;

a Luminescence Immuno Assay (LIA) technique;

a Kinetic Interaction of Microparticles in Solution (KIMS) technique;

a Radio Enzymatic assay (REA) technique.

Since also the liquid samples obtained by such an extraction solution are well-suited for use in instrumental immunochemical tests, the method reduces costs and health risks for operators in charge of carrying out these tests, as well as disposal costs of waste material resulting therefrom.

Furthermore, the invention overcomes the limitations of most substances adapted to dissolve the drugs of abuse, which are well-suited for a subsequent qualitative/quantitative instrumental immunochemical test, but are expensive and detrimental to health and environment.

The step of bringing the keratin material into contact with the extraction composition can comprise a step of maintaining the extraction composition in contact with the keratin material at a treatment temperature of at least 50° C. for a predetermined high-temperature treatment time, as required for extracting the drug and/or the metabolite at this temperature.

In particular the treatment temperature can be higher than 70° C., more in particular the treatment temperature can be higher than 90° C.

Advantageously, the extraction composition comprises water. In particular the extraction composition can comprise an aqueous solution of urea at a predetermined urea concentration and at a predetermined pH. In this case, the step of maintaining said extraction composition in contact with said keratin material at a treatment temperature comprises a step of boiling the water, i.e. the aqueous solution, and the high-temperature treatment time, during which the boiling is continued, is set between 10 minutes and 20 minutes, for example the boiling is continued during about 15 minutes, as required for extracting the drug and/or the metabolite at boiling conditions, i.e. at about 100° C.

Therefore, the time required for the extraction, according to the invention, is remarkably lower than the time required when using a well-known solvent. This reduces the time for preparing the extracts suitable for semi-quantitative analysis.

Moreover, the treatment conditions, in particular the boiling conditions according to the method can be easily obtained even at home, in particular the boiling temperature of the solution, about water boiling point, is a useful reference for defining an easily repeatable standard extraction procedure.

Preferably, the urea concentration of the aqueous solution is set between 0.1 mol/litre and 3.0 mol/litre. In particular, the urea concentration can be set between 0.5 mol/litre and 2.0 mol/litre, more in particular, the urea concentration is set between 0.7 and 1.4 mol/litre, even more in particular, the urea concentration is about 1 mol/litre. Preferably, the aqueous solution pH is set between 4.5 and 7. In particular, the pH is set between 5.0 and 6.0, more in particular, the pH is set between 5.1 and 5.5, even more in particular, the pH is about 5.2. To this purpose, the aqueous solution can comprise a buffer system, for example a system consisting of sodium hydrogen phosphate and sodium dihydrogen phosphate (K₂HPO₄ and KH₂PO₄).

As an alternative, the step of contact can provide exposing the extraction composition in contact with the keratin material to microwaves, for example in a common microwave oven, for a predetermined microwave treatment time.

Advantageously, the step of microwave treatment is carried out by exposing the composition in contact with the keratin material to microwaves to at a power set between 150 W and 750 W, in particular between 200 and 550 W, more in particular, between 250 W and 500 W. The microwave treatment time can be set between 5 seconds and 30 seconds. In particular, the microwave treatment time is set between 10 and 20 seconds. More in particular, the microwave treatment time is about 15 seconds.

The microwave treatment further reduces the extraction time, with respect to the time that is required, according to the prior art, for preparing liquid samples for professional immunochemical testing of a keratin material.

Furthermore, the conditions required by the method can be easily obtained even at home, by a common microwave oven, which allows defining an easily repeatable standard extraction procedure.

No stirring is advantageously needed during the step of contact, irrelevant to whether the latter is carried out by means of heating and maintaining the solution at a temperature, in particular at boiling point, or it is carried out by exposition to microwaves.

The drug of abuse that can be extracted with the extraction composition, according to the invention, can comprise a drug, or several drugs, selected from the group consisting of amphetamine; barbiturate drugs; benzodiazepines; buprenorphine; cocaine; cotinine; EDDP; phencyclidine; ketamine; marijuana; methadone; methamphetamine; opiates; oxycodone; propoxyphene. Such list comprises the drugs of abuse of higher diffusion.

In particular said drug of abuse comprises cocaine and the treatment temperature is higher than 60° C., and a step is provided of selecting the pH according to the extraction temperature, in order to obtain a substantially quantitative conversion of the cocaine into benzoylecgonine during the step of extracting.

Therefore, the method and the extraction composition according to the invention have specific advantages for assessing whether a subject has taken particular drugs of abuse, typically cocaine. In this case, besides cocaine, a much smaller amount of its metabolite benzoylecgonine is fixed in the consumer's keratin material. The quick “on site” tests, as well as the tests carried out by laboratory instruments, are carried out by detector devices that are sensitive for the sole benzoylecgonine. Now, the inventors have surprisingly realised that cocaine is substantially fully converted into benzoylecgonine while contacting the keratin material with the extraction composition, typically with an urea aqueous solution. For this reason, the resulting extract contains an amount of benzoylecgonine which is the sum of the benzoylecgonine already present in the keratin material and of the benzoylecgonine obtained from the conversion of the extracted cocaine. Therefore, with the extraction solution and with the method according to the invention, the “on site” tests and the tests carried out by professional instruments are much more effective for establishing a case of consumption of cocaine, than the tests in which such conversion does not take place.

In particular the urea derivative or derivatives present in the extraction composition can be selected from the group consisting of: thiourea, tetraethylurea, tetramethylurea and idantoin. In particular, the extraction composition comprises an aqueous solution of thiourea at a predetermined thiourea concentration and at a predetermined pH.

Thiourea differs from the other derivatives, and mainly from urea itself, since it produces an extract in which cocaine and benzoylecgonine are present substantially in the same amount ratio than in the keratin material. In fact, thiourea is not able to promote the conversion of cocaine into benzoylecgonine.

It falls within the field of the invention also a composition comprising a compound selected among urea and urea derivatives for extracting a drug of abuse or a metabolite thereof from a subject's keratin material, in a method as described above, thus obtaining an extract that contains the drug of abuse and/or the metabolite.

It falls within the scope of the invention also the use of a composition containing a compound selected among urea and urea derivatives in a step of extracting a drug of abuse or a metabolite thereof from a subject's keratin material in a method as described above, for assessing whether the drug of abuse and/or the metabolite is present in the keratin material. The composition can have at least one of the above indicated optional features.

According to another aspect of the invention, the above mentioned objects are achieved by a device, i.e. a kit, for extracting a drug of abuse or a metabolite thereof from a subject's keratin material, obtaining an extract that contains the drug of abuse and/or the metabolite, the device comprising:
a preparation container configured for receiving a predetermined amount of the keratin material;
an predetermined amount of an extraction composition containing a compound selected among urea and urea derivatives;
an extraction container configured for receiving the predetermined amount of extraction composition along with the predetermined amount of said keratin material;
a means for bringing the amount of the keratin material into contact with the amount of the extraction composition in the extraction container;
an immunochromatographic quick test device provided with a feeding means for feeding the extract.

In addition to the advantages pointed out when describing the various features of the method, the device according to the invention allows preparing the extract in a simple way, since it makes the step of weighing the amount of keratin material unnecessary.

Advantageously, the extraction container is a cylindrical container that has a level mark corresponding to the amount of the keratin material, cut at a predetermined length.

In an exemplary embodiment, the extraction composition comprises a urea aqueous solution at a predetermined urea concentration and at a predetermined pH. In particular, the urea concentration is set between 0.1 and 3.0 mol/litre, more in particular, between 0.5 and 2.0 mol/litre, more in particular, the urea concentration is set between 0.7 and 1.4 mol/litre, even more in particular, the concentration is about 1 mol/litre. In particular, the pH is set between 4.5 and 7, more in particular, between 5.0 and 6.0, more in particular, the pH is set between 5.1 and 5.5, even more in particular, the pH is about 5.2.

In an exemplary embodiment, the urea derivatives are selected from the group consisting of: thiourea, tetraethylurea, tetramethylurea and idantoin.

Advantageously, the extraction container of the kit is configured for withstanding an extraction temperature, in particular 100° C., for a predetermined time, in particular for 20 minutes and/or for withstanding microwaves of a predetermined power, in particular set between 150 W and 750 W, in particular for a predetermined time, for example about 20 seconds.

### BRIEF DESCRIPTION OF THE DRAWINGS

The invention will be now shown with the description of exemplary embodiments of the method and of the device for extracting a drug of abuse or a metabolite thereof from a keratin material, exemplifying but not limitative, with reference to the attached drawings, in which like reference characters designate the same or similar parts, throughout the figures, of which:

FIG. 1 diagrammatically shows an “on site” kit, i.e. a conventional device for carrying out quick tests on samples of saliva;

FIG. 2 shows a kit for extracting a drug of abuse or a metabolite thereof from a keratin material;

FIGS. 3 and 4 show multiple kits for extracting a drug of abuse or a metabolite thereof from a keratin material, in a first exemplary embodiment;

FIG. 5 shows a kit for carrying out an on site test for assessing the presence of a drug of abuse or of a metabolite thereof in a keratin material;

FIG. 6 shows a multiple kits for carrying out an on site test for assessing the presence of a drug of abuse or of a metabolite thereof in a keratin material;

FIGS. 7-11 show the use of the kit of FIGS. 2-4 at prearranging an amount of keratin material for the extraction;

FIGS. 12-13 show the use of the kit in a first part of the step of contact of the amount of keratin material with the extraction composition;

FIG. 14 shows a step of maintaining the extraction composition in contact with the keratin material at a predetermined treatment temperature for a predetermined treatment time;

FIG. 15 shows a step of exposing the extraction composition along with the keratin material to microwaves, for a predetermined treatment time;

FIG. 16 shows the extraction container after the treating of FIG. 14 or 15, containing an extract to be checked;

FIGS. 17 and 18 show a step of treating the extract in a quick on site immunochromatographic test device.

### DESCRIPTION OF PREFERRED EXEMPLARY EMBODIMENTS

With reference to FIG. 2, a disposable kit 20 is described for extracting a drug of abuse and/or a metabolite thereof that can be present in a keratin material, by an extraction composition 23 to obtain a liquid extract containing said possible drug of abuse and/or a metabolite thereof. Kit 20 comprises a preparation container 21 for preparing the keratin material that is configured to receive a predetermined amount of keratin material. Preparation container 21 can be, for instance, a common Falcon test tube.

In an exemplary embodiment, kit 20 can comprise also common scissors 33 for suitably chopping up the keratin material in preparation container 21. Kit 20 also comprises an amount of an extraction composition 23 containing urea or a urea derivative, in particular selected among Thiourea, Tetraethylurea, Tetramethylurea and Idantoin. Extraction composition 23 can be supplied in a single-dose bottle 24 of kit 20, so large as to receive an amount of the composition suitable for a single test, i.e. for treating a suitable amount of a single subject's keratin material. For example, the amount of the extraction solution can be about 500 microlitres.

Kit 20 also comprises an extraction container 22 arranged to receive the predetermined amount of extraction composition 23 along with a predetermined amount of keratin material, enough to obtain a liquid extract to be used in a test for revealing the presence of a drug of abuse.

Extraction container 22 is made of a preferably plastic material, suitable for withstanding an extraction temperature, for example about 100° C. and/or of a material suitable for withstanding microwaves of a predetermined power, for example about 150-750 W, during a predetermined treatment time.

Extraction container 22 advantageously has a hermetic plug 25 for sealing container 22 during the extraction, as described hereinafter.

For instance, extraction container 22 can have the shape of a test tube, more in particular, the shape of an Eppendorf vial.

Kit 20 can also comprise a pestle 27, preferably of plastic material, that can be arranged in extraction container 22.

In an advantageous exemplary embodiment, extraction container 22 has a level mark 29 that corresponds to the volume of a suitably chopped and compressed amount of keratin material, which in turn corresponds to a predetermined mass of keratin material large enough to allow an extraction.

This way, a user who pushes the keratin material down to lever mark 29 is sure that he/she's using use a suitable amount of keratin material.

In an exemplary embodiment, kit 20 can also comprise a pair of tweezers 34 such for picking up the amount of keratin material prepared in the preparation container 21 and to put it down into extraction container 22, into which extraction composition 23 must be introduced as well.

A notch, not shown, can be optionally provided also in preparation container 21, in order to preliminarily estimate the amount of keratin material 23.

In an exemplary embodiment, kit 20 can also comprise a pipette 35, for example a Pasteur pipette, for withdrawing the extract from extraction container 22 after the extracting it, and for dropping it into a feeding section of a device, in order to check the presence of at least one dugs and/or of a respective metabolite.

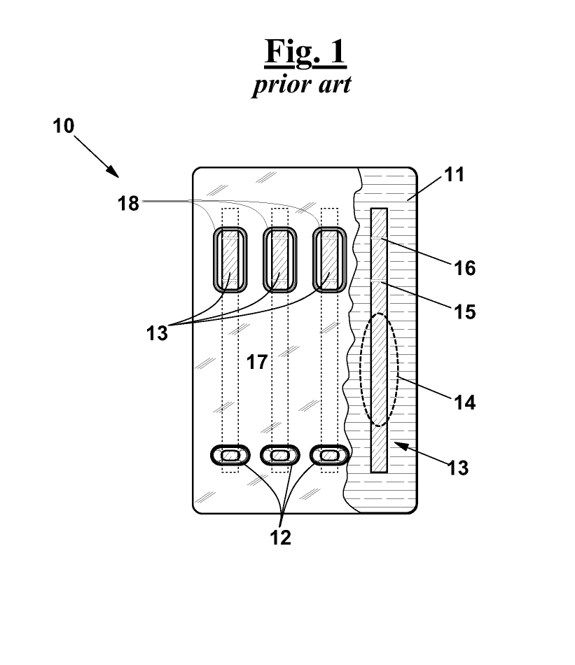

For example, the feeding section can be a well 12 of an “on site” kit as shown in FIG. 1.

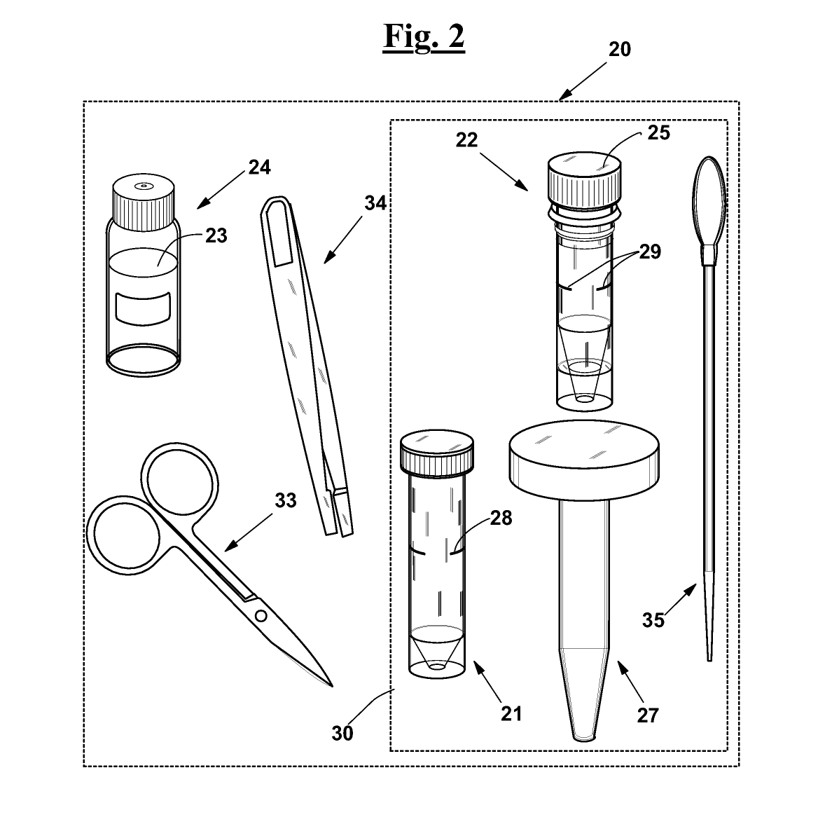

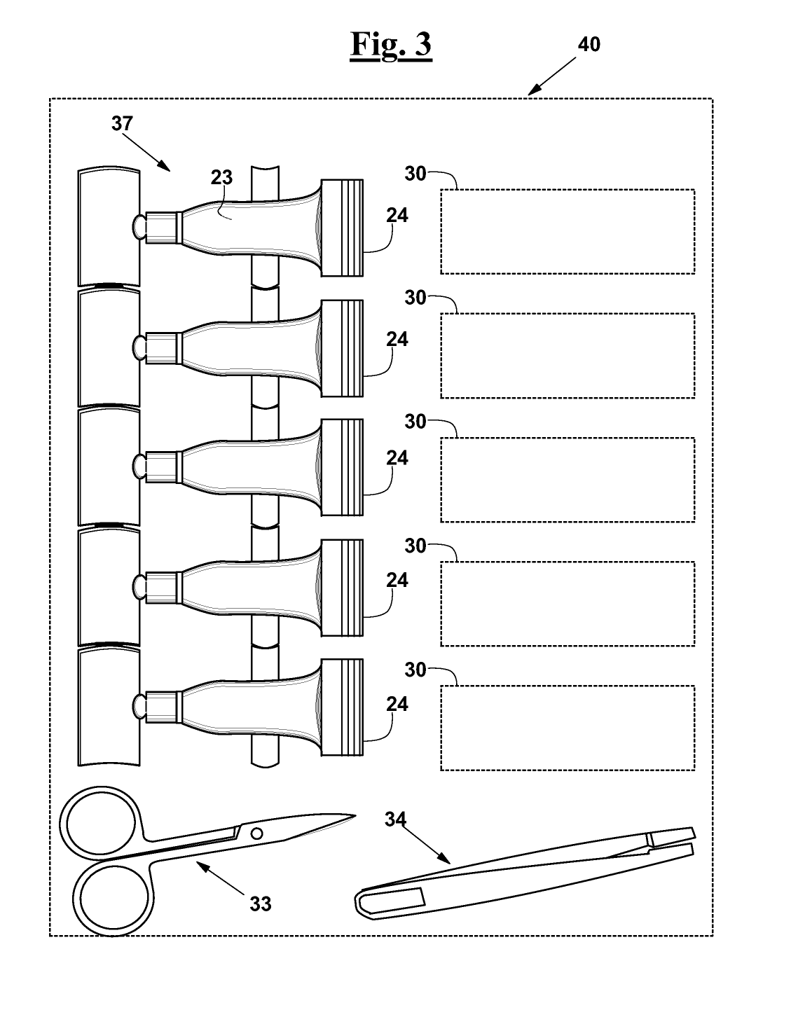

With reference to FIGS. 3 and 4, kits 40 and 50 are described for extracting a drug of abuse and/or a metabolite thereof that can be present in a plurality of amounts of keratin material of a plurality of subjects.

Kit 40 comprises a multiple of an amount of the composition suitable for a single test. For instance, kit 40 can contain a plurality of small single-dose bottles 24, each containing an amount of extraction solution suitable for a single test, preferably in the form of a group 37 of printed separable single-dose containers.

Kit 40 also comprises so many disposable modules 30 as small single-dose bottles 24. Each module 30 comprises a preparation container 21 and an extraction container 22 and, preferably, a pestle 27 and/or a pipette 35, as described with reference to FIG. 2.

Kit 50 comprises a bottle 38 of an amount of extraction solution 23 for running a large number of tests. Kit 50 also comprises a plurality of disposable modules 30, of the type described with reference to kit 30. In this case, each module 30 can comprise an additional pipette 35, or a dropper, for picking up a predetermined amount of extraction solution 23 from bottle 38, and for dropping it into extraction test tube 22.

Multiple kits 40 and 50, which comprise a plurality of single-dose amounts of extraction solution 23 and a plurality of disposable modules 30, can be advantageously used in health institutions, for example, for carrying out screening qualitative on a plurality of subjects, in order to establish who of these subjects has to be more deeply investigated.

Kits 40 and 50 advantageously comprise scissors 33 for chopping the keratin material and pair of tweezers 34 for transferring the keratin material from preparation container 21 to extraction container 22.

Extraction container 22, in particular kit 50, can have a second level mark, not shown, larger than recess 29, corresponding to amount of extraction solution 23 needed for carrying out an extraction.

In an exemplary embodiment, extraction test tube 22 of kit 20,40,50 can comprise an own heating means, not shown, which can be used as an alternative to boiling water or other heating means outside kit 20,40,50. For instance, the own heating means can comprise a circuit in which a heating resistance is arranged on extraction test tube 22 and is/can be associated with a battery, the heating circuit being designed for allowing a current during a time long enough to bring the content of extraction test tube 22 to the extraction temperature and to maintain it at the extraction temperature for a suitable extraction time.

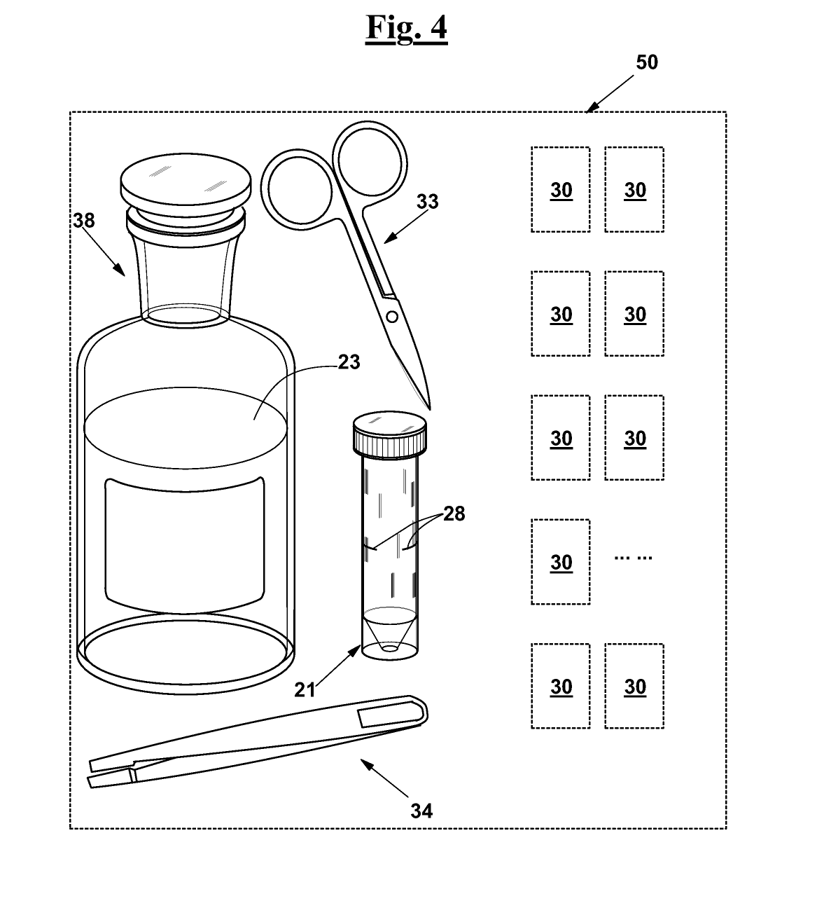

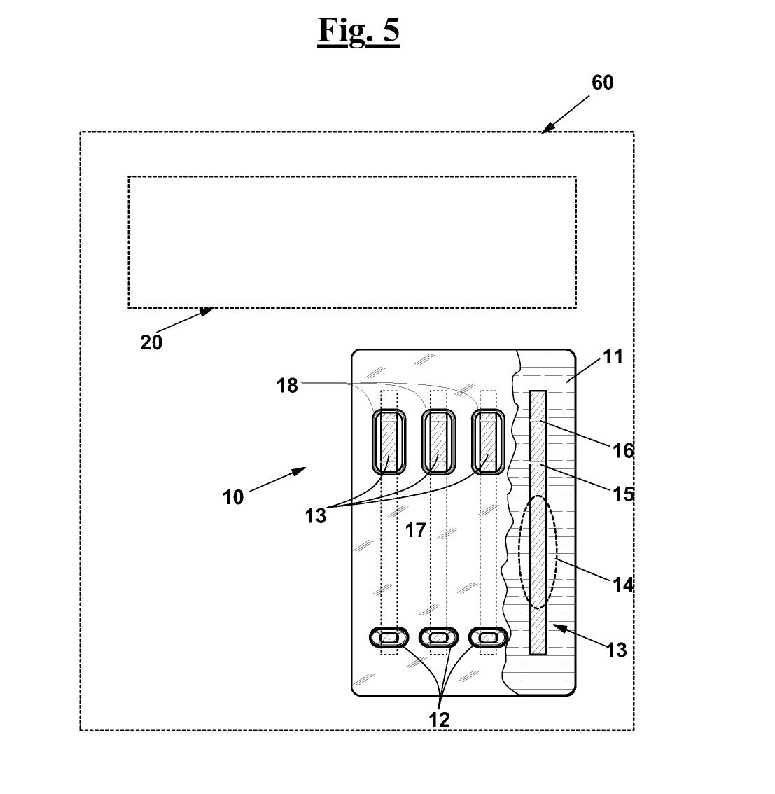

With reference to FIG. 5, a disposable kit 60 is described for assessing the presence of a drug of abuse and/or of a metabolite thereof in a keratin material. Kit 60 comprises a kit 20 as described with reference to FIG. 2, for extracting the possible drug of abuse or a metabolite thereof from the keratin material, and also comprises a kit 10 for carrying out a quick on site immunochromatographic test, for example, as described with reference to FIG. 1, comprising a feeding means 12 for feeding the extract.

With reference to FIG. 6, a kit 70 is described for checking the presence of a drug of abuse and/or of a metabolite thereof in a plurality of samples of keratin material, in particular, coming from a plurality of subjects. Kit 70 comprises a kit 40 or 50 as described with reference to FIG. 3 or to FIG. 4, and also comprises a plurality of immunochromatographic quick test devices 10, for example, of the type described with reference to FIG. 1.

As an alternative, this device can be a quick “on site” test kit, for example, a test commonly used for assessing the presence of a drug in the saliva. In this case, a kit 40 for assessing the presence of a drug or of a metabolite thereof comprises above described extraction kit 20 or 30 and such a quick “on site” test kit 10, whose structure and operation have been described along with the prior art, with reference to FIG. 1.

A detailed instruction sheet, not shown, is available teach how to use kits 20, 40, 50, 60, 70.

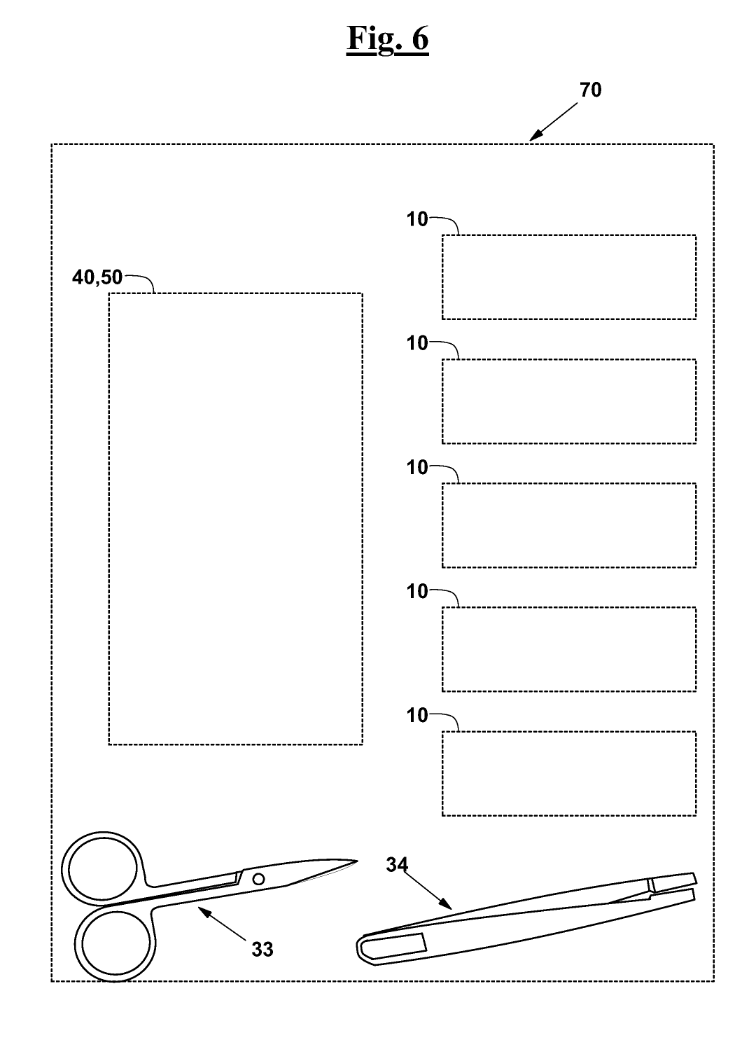

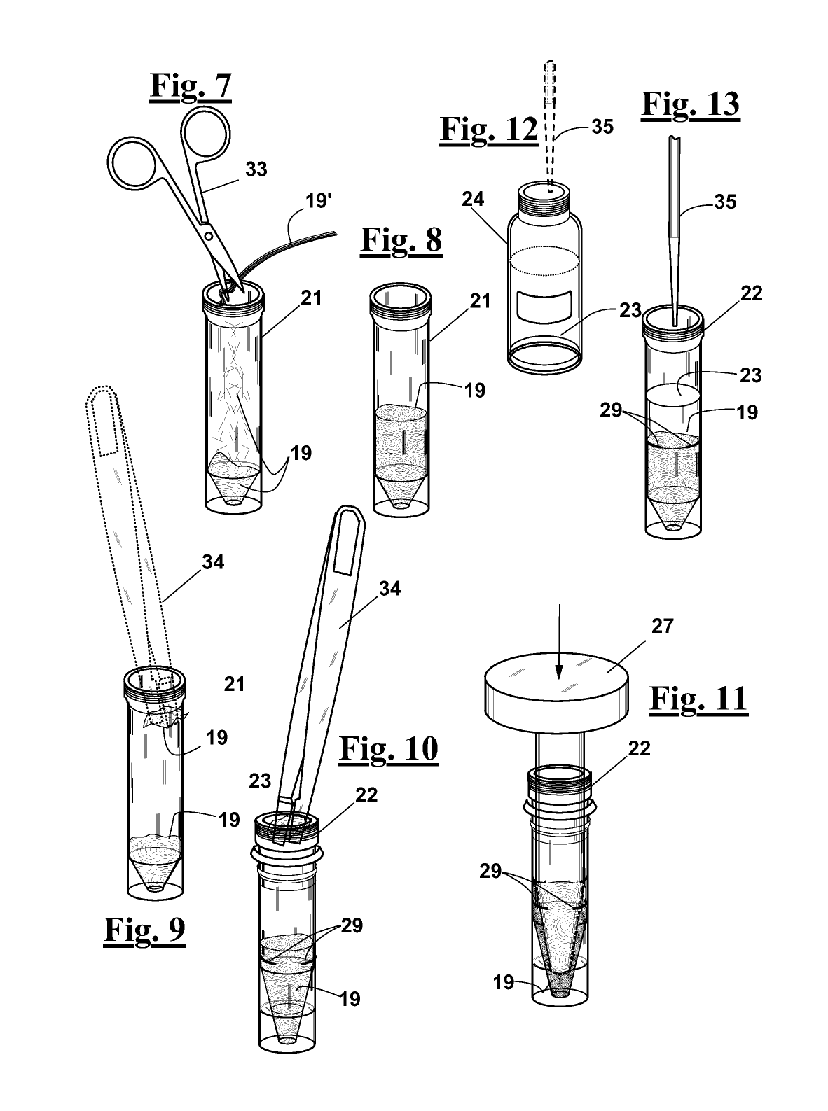

FIG. 7 shows a step of prearranging keratin material 19 into a preparation container 21 of a kit 20,40,50, wherein a material such as hair 19′ is chopped by means of scissors 33, within container 21, until it reaches a level high enough to allow the extraction, as shown in FIG. 8.

As FIGS. 9 and 10 show, an amount of keratin material 19 is then taken from container 21 and is put into extraction container 22, which has a level mark 29, for example, by tweezers 34. Successively, and preferably even during the previous step, keratin material 19 is compressed within container 22 by pestle 27, in order to bring the level of keratin material 19 to level mark 29, as shown in FIG. 11.

Afterwards, as shown by FIGS. 12 and 13, an amount of extraction solution 23 is taken from bottle 24, for example by pipette 35, and is put into container 22, in order to provide a contact between solution 23 and material 19.

Extraction container 22, prepared as above, is closed by hermetic plug 25 and is subjected to an extraction treatment.

According to an exemplary embodiment, extraction container 22 is brought to an extraction temperature and is kept at that temperature for an extraction time that can be as song as required by the extraction temperature. For instance, as shown in FIG. 14, container 22 is at least partially immersed in a bath of boiling water 80, i.e. a bath of water at about 100° C., for an extraction time 81 normally ranging from 10′ to 20′, typically of about 15′, for example in a common heatable kitchen or laboratory container 84. As an alternative, the extraction can be also occur by exposing container 22 to steam from boiling water, for a predetermined time.

According to another exemplary embodiment, extraction container 22 is exposed to microwaves, for example it is maintained in a common microwave oven 82 for a time 83 of about 15″, as shown in FIG. 15, at a radiation power set between 150 W and 750 W, in particular between 200 and 550 W, more in particular, between 250 and 500 W.

FIG. 16 shows an extraction container 22 after the extraction step of FIG. 14 or 15, containing, besides a keratin material residue 19, an extract 28 that can include a drug of abuse or a metabolite thereof, which can have been contained in hair material 19′.

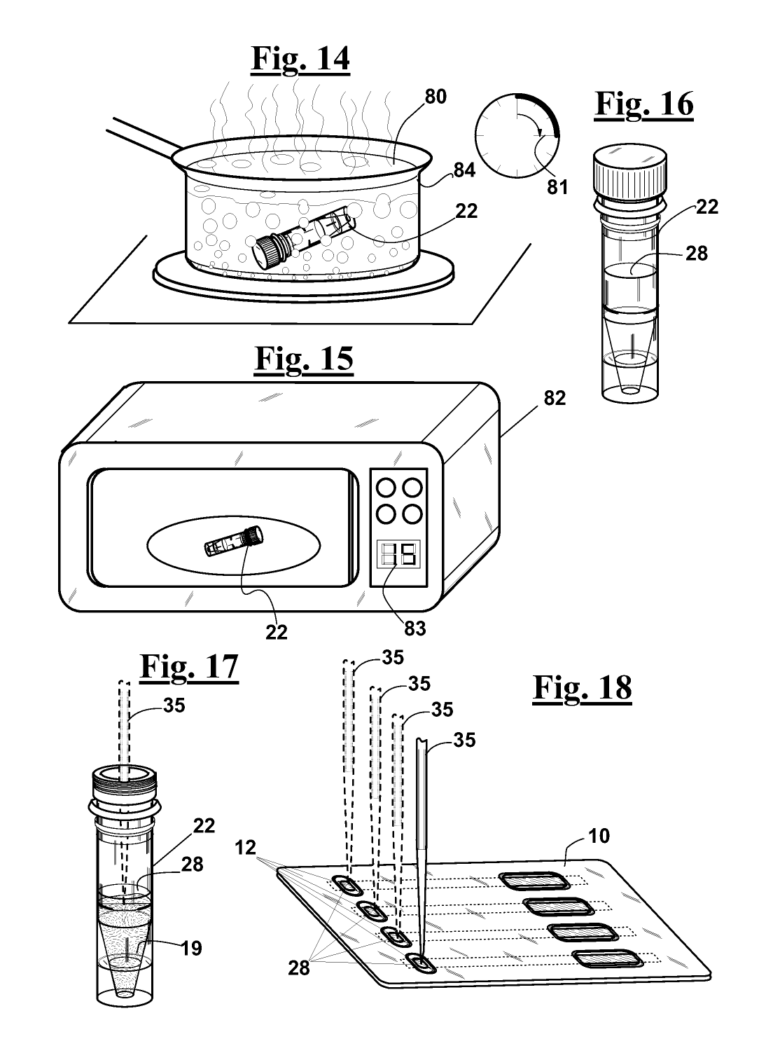

The extract 28 can be then subject to an immunochemical test of known type, for instance by a professional instrumental test, which can use an a technique selected from the group consisting of: a Radio Immuno Assay (RIA) technique; an Enzyme Immuno Assay (EIA) technique; a MEIA technique (Microparticles Enzyme Immuno Assay); a CEDIA technique (Cloned Enzyme Donor Immuno Assay); a Fluorescence Polarization Immuno Assay (FPIA) technique; a Luminescence Immuno Assay (LIA) technique; a Kinetic Interaction of Microparticles in Solution (KIMS) technique; a Radio Enzymatic assay (REA) technique, or, as shown in FIGS. 17 and 18, in an “on site” kit 10 as described with reference to FIG. 1, wherein the extract 28 is taken from the container 22 by disposable pipette 35, and is put into the well/s 12 of kit 10.

### Examples

100 real samples of keratin material have been collected while performing conventional laboratory tests. The prearranged material comprised both positive and negative samples.

The extraction composition was a 98% minimum purity urea aqueous solution at 1M concentration, buffered pH 5.2 by a 0.1 mol/litre phosphate buffer.

The extraction composition, after adding the keratin material, has been maintained at 100° C. for 15 minutes by a conventional heating means and/or has been exposed to microwaves at a power of 300-450 W, for 15 seconds.

Portions of each obtained sample have been also analysed by a process GC-MS procedure, i.e. a procedure based on a gas chromatographic analysis and on mass spectrometry.

For the gas chromatographic analysis, a QP2010 Ultra GC./MS equipped with an AOC-20i autosampler have been used, both provided by Shimadzu company.

The chromatographic analysis has been carried out by a 15 metres Rtx-5MS column filled with Crossbond® 5% biphenyl/ 95% dimethyl polysiloxane, which had an inner diameter of 0.25 mm and a thickness of the steady phase of 0.25 mm (Restek). The temperature of the injector has been maintained at 270° C., with a injection volume of 1 ml in “splitless” mode, in which the whole injected sample enters into the chromatographic column without drawing any sample portion at the injector. The initial temperature the oven, i.e. 100° C., has been maintained for 90 seconds and then it has been increased at a 17° C./min rate up to 320° C., temperature that has been kept for 1 minute. The “transfer line” has been kept at a temperature of 250° C., while the ionic source has been maintained at 200° C. Helium at a flowrate of 1.5 ml/min as carrier has been used.

Briefly, the results obtained by the test according to the invention and the results obtained by GC-MS procedure have shown a total correspondence between the two methods.

The foregoing description exemplary embodiments of the kit according to the invention, and of examples of carrying out a method according to the invention, will so fully reveal the invention according to the conceptual point of view, so that others, by applying current knowledge, will be able to modify and/or adapt in various applications the specific exemplary embodiments without further research and without parting from the invention, and, accordingly, it is meant that such adaptations and modifications will have to be considered as equivalent to the specific embodiments. The means and the materials to realise the different functions described herein could have a different nature without, for this reason, departing from the scope of the invention. It is to be understood that the phraseology or terminology that is employed herein is for the purpose of description and not of limitation.

1. A method for assessing whether a drug of abuse and/or a metabolite of a drug of abuse is present in a keratin material, said method comprising:
a step of extracting said drug of abuse and/or said metabolite from said keratin material, said step of extracting comprising:
prearranging an amount of said keratin material;
prearranging an amount of an extraction composition containing a compound selected from the group consisting of urea and urea derivatives;
bringing said amount of said keratin material into contact with said amount of said extraction composition, obtaining an extract containing said drug of abuse and/or said metabolite;
a step of analysing said extract by an antigen-antibody technique comprising:
performing a reaction of said drug of abuse and/or said metabolite, which acts as an antigen, with a specific antibody;
detecting said antigen-antibody reaction.

2. A method according to claim 1, wherein said reaction of said drug of abuse and/or of said metabolite with said specific antibody is a first reaction, and said method comprises a step of comparing said first reaction with a second reaction between said antibody and a reference antigen for said drug of abuse and/or for said metabolite.

3. A method according to claim 2, wherein said reference antigen is a marked antigen adapted to produce a visually detectable chromophore compound in said second reaction with said antibody.

4. A method according to claim 3, wherein said reference antigen and said specific antibody are arranged on a respective strip of a immunochromatographic quick test device.

5. A method according to claim 1, wherein said antigen-antibody technique is a technique wherein said step of detecting is carried out instrumentally, said technique being selected from the group consisting of:
a Radio Immuno Assay (RIA) technique;
an Enzyme Immuno Assay (EIA) technique;
a MEIA technique (Microparticles Enzyme Immuno Assay);
a CEDIA technique (Cloned Enzyme Donor Immuno Assay);
a Fluorescence Polarization Immuno Assay (FPIA) technique;
a Luminescence Immuno Assay (LIA) technique;
a Kinetic Interaction of Microparticles in Solution (KIMS) technique;
a Radio Enzymatic assay (REA) technique.

6. A method according to claim 1, wherein said step of bringing said amount of said keratin material into contact with said amount of said extraction composition comprises a step of maintaining said extraction composition in contact with said keratin material at a treatment temperature of at least 50° C. for a predetermined high-temperature treatment time,
in particular, said treatment temperature is higher than 70° C.,
more in particular, said treatment temperature is higher than 90° C.

7. A method according to claim 1, wherein said step of bringing said amount of said keratin material into contact with said amount of said extraction composition comprises a step of exposing said extraction composition in contact with said keratin material to microwaves, for a predetermined microwaves treatment time.

8. A method according to claim 7, wherein said microwaves are applied to said composition in contact with said keratin material at a power set between 150 W and 750 W, in particular between 200 W and 550 W, more in particular, between 250 W and 450 W, and said microwave treatment time is set between 5 seconds and 30 seconds,
in particular, said microwave treatment time is set between 10 and 20 seconds,
more in particular, said microwave treatment time is about 15 seconds.

9. A method according to claim 1, wherein said extraction composition comprises water.

10. A method according to claim 1, wherein said extraction composition comprises an aqueous solution of urea at a predetermined urea concentration and at a predetermined pH.

11. A method according to claim 6, wherein said step of maintaining said extraction composition in contact with said keratin material at a treatment temperature comprises a step of boiling said water, and said high-temperature treatment time is set between 10 minutes and 20 minutes.

12. A method according to claim 10, wherein said urea concentration is set between 0.1 mol/litre and 3.0 mol/litre,
in particular, said urea concentration is set between 0.5 mol/litre and 2.0 mol/litre,
more in particular, said urea concentration is set between 0.7 mol/litre and 1.4 mol/litre.

13. A method according to claim 10, wherein said pH is set between 4.5 and 7,
in particular, said pH is set between 5.0 and 6.0′ more in particular, said pH is set between 5.1 and 5.5.

14. A method according to claim 1, wherein said drug of abuse is selected from the group consisting of:
amphetamine; barbiturate drugs; benzodiazepines; buprenorphine; cocaine; cotinine; EDDP; phencyclidine; ketamine; marijuana; methadone; methamphetamine; opiates; oxycodone; propoxyphene.

15. A method according to claim 1, wherein said drug of abuse comprises cocaine and said treatment temperature is higher than 60° C., and a step is provided of selecting said pH according to said extraction temperature, in order to obtain a substantially quantitative conversion of said cocaine into benzoylecgonine during said step of extracting.

16. A method according to claim 1, wherein said urea derivatives are selected from the group consisting of: thiourea, tetraethylurea, tetramethylurea and idantoin.

17. A method according to claim 1, wherein said extraction composition comprises an aqueous solution of thiourea at a predetermined thiourea concentration and at a predetermined pH.

18. (canceled)

19. A kit for extracting a drug of abuse or a metabolite of a drug of abuse from a keratin material (19) and for obtaining an extract (28) containing said drug of abuse and/or said metabolite, said kit comprising:
a preparation container (21) configured for receiving a predetermined amount of said keratin material (19);
a predetermined amount of an extraction composition (23) containing a compound selected from the group consisting of urea and urea derivatives;
an extraction container (22) configured for receiving said predetermined amount of said extraction composition (23) along with said predetermined amount of said keratin material (19);
a means for bringing said amount of said keratin material (19) into contact with said amount of said extraction composition (23) in said extraction container (22);
an immunochromatographic quick test device (10) provided with a feeding means (12) for feeding said extract (28).

20. A kit according to claim 19, wherein said extraction container (22) is a cylindrical container having a level mark (29) corresponding to said amount of said keratin material (19), cut at a predetermined length.

21. A kit according to claim 19, wherein said extraction composition (23) comprises an aqueous solution of urea at a predetermined urea concentration and at a predetermined pH,
in particular, said urea concentration is set between 0.1 mol/litre and 3 mol/litre, more in particular, said urea concentration is set between 0.5 and 2.0, even more in particular, said urea concentration is set between 0.7 mol/litre and 1.4 mol/litre,
in particular, said pH is set between 4.5 and 7, more in particular, said pH is set between 5.0 and 6.0, more in particular, the pH is set between 5.1 and 5.5.

22. A kit according to claim 19, wherein said urea derivatives are selected from the group consisting of: thiourea, tetraethylurea, tetramethylurea and idantoin.

23. A kit according to claim 19, wherein said extraction container (22) is configured for withstanding an extraction temperature, in particular 100° C., for a predetermined time, in particular for 20 minutes and/or withstanding microwaves of a predetermined power, in particular set between 150 W and 750 W, for a predetermined time, in particular for 20 seconds.
